(19) United States
(12) Patent Application Publication
(10) Pub. No.: US 2014/0273727 A1
(43) Pub. Date: Sep. 18, 2014

(54) Striker for Bird or Turkey Calls

(71) Applicant: Eric Huff, Highland, OH (US)

(72) Inventor: Eric Huff, Highland, OH (US)

(21) Appl. No.: 14/216,249

(22) Filed: Mar. 17, 2014

Related U.S. Application Data
(60) Provisional application No. 61/788,215, filed on Mar. 15, 2013.

(51) Int. Cl. A01M 31/00

(52) U.S. Cl. CPC A01M 31/004
USPC 446/418

(57) ABSTRACT

A striker assembly including a stern, a striker head, and an insert for the striker head. The insert has an exposed surface of an abrasive or other suitable material for conditioning a striker surface of a bird call device and/or a recess containing a material for cleaning, shaping and/or re-contouring the tip of the stern.

### FIELD OF THE INVENTION

The present invention relates to an improved striker for bird or turkey calls and in particular slate turkey calls.

Turkey calls are widely used by turkey hunters for the purpose of creating sounds to attract turkeys to the vicinity of the hunter. Bird and turkey calls are well known in the art and exemplary calls are shown and described in one or more of the following patent documents, the contents of which are hereby expressly and fully incorporated herein by reference: Tannehill U.S. Pat. No. 2,958,157; Wisor U.S. Pat. No. 3,208,184; Morris U.S. Pat. No. 5,961,367; Anderson U.S. Pat. No. 6,210,2527 Primes et al. U.S. Pat. No. 6,540,582; Rydbom U.S. Pat. No. 8,147,290; Coffield U.S. Patent Application Publication No. US20080261485; Coffield U.S. Patent Application Publication No. US20100151769; and Cubbedge U.S. Patent Application Publication No. US2010/0216371.

One or more of the foregoing patents show typical turkey or bird call devices, which may have a slate or other surface upon which a striker is rubbed or moved in a frictional engagement to create the desired sound. One or more of the foregoing patents also show various types of strikers to be used with the bird or turkey call. Although it is believed that none of the foregoing patents or published applications describe or disclose a striker of the type that is disclosed and claimed herein, these prior patents and published applications are incorporated herein by reference for the known teachings they contain; specifically, as to the slate surface or body against which the striker of the present invention may be engaged to create the desired call effect.

It is typical for a hunter to condition the slate or other surface of the turkey call using a material such as emery cloth, sandpaper or other material having an abrasive surface. Oftentimes the hunter simply carries a loose detached piece of the abrasive material for us conditioning the surface of the turkey call. This presents various drawbacks as the abrasive material can be lost or dropped by the hunter. It is also important to the hunter to be able to condition the tip of the striker for the bird call. Again various materials can be used to condition the tip of the striker and it is most common for that material to be carried loosely by the hunter.

The known prior art bird and turkey calls and strikers for those calls will typically include a striker tip or stem and a striker head or handle portion.

### SUMMARY OF THE INVENTION

The invention disclosed herein is directed to a striker for turkey or other bird calls that includes a stem, a striker head and an insert for the striker head which itself includes an abrasive material for conditioning or reconditioning the surface, which may be a slate surface, of a friction call. The insert for the turkey call striker head also includes a recess containing a material to re-contour the radius of the end of the striker stem. The abrasive material in the recess of the striker head insert can be one of many known abrasive materials for shaping, contouring, and/or cleaning the tip or end of the stem, including, sandpaper and other abrasive materials. The external surface of the turkey striker head insert is provided with an exposed surface having an abrasive material affixed thereto or integral with the insert itself, Such materials, including sandpaper; emery paper and other abrasive materials, are known in the art.

The invention includes the combination of a bird or turkey call striker having a stem, a striker head and an insert for the striker head which includes one or both of an external abrasive material for conditioning and/or reconditioning the slate surface of a friction call, as well as an internal recess containing an abrasive material for conditioning, contouring and/or cleaning the radius of the end of the striker stem. This combination provides numerous advantages and combines the needs of the hunter into a single device for both providing the striker used with the bird call as well as the conditioning materials for the surface of the friction call itself as well as the stem of the striker.

### BRIEF DESCRIPTION OF THE DRAWINGS

FIG. 1 is an exploded perspective view of an embodiment of the striker of the present invention.

FIG. 2 is a side cross-section view of a call striker of the present invention showing the insert frictionally fitted into the distal end of the turkey striker head by means of an O-ring.

FIG. 3 is a side view of the striker of the present invention.

FIG. 4 is a cross-sectional view of the insert for the call striker of the present invention.

FIG. 5 is a side view of the call striker head.

FIG. 6 is a side view of an embodiment of the striker stem.

### DETAILED DESCRIPTION OF THE INVENTION

The figures show the general details of an embodiment of he invention, including various dimensions and materials. It will be appreciated that the invention is not intended to be limited to the specific dimensions described herein, nor to the specific materials identified herein. These dimensions and materials are exemplary and may be modified as necessary for the particular situation.

FIG. 1 shows a perspective view of an embodiment of bird or turkey call striker 10 of the present invention. For ease of reference herein, the device will be referred to as call striker without limitation to a particular type of call striker. In other words, the invention is not limited to a turkey call striker and is equally applicable as a call striker for a variety of bird callers.

More specifically with reference to FIG. 1, call striker 10 includes a stem portion 12, a striker head portion 14 and an insert 16. As shown in FIG. 1, insert 16 is shown in two different operative positions. One position shows the insert 16 adjacent to striker head 14, such as when it is about to be inserted into and engaged head 14 or immediately after being disengaged from head 14. A second position of insert 16 is shown adjacent to the tip 18 of stem 12. In this second position, insert 16 is oriented so that the recess 20 within insert 16 is adjacent to tip 18 for the purpose of cleaning, shaping and/or re-contouring the radius of tip 18 of stem 12, Although not shown in FIG. 1, there is an abrasive material surface within recess 20 which facilitates the cleaning, shaping and/or re-contouring of tip 18. It is noted that insert 16 may have an abrasive surface 22 affixed thereto or integral therewith in any suitable manner to provide an abrasive surface for conditioning the surface of a bird caller.

FIG. 2 is a cross-section of the call striker shown in FIG. 1, in a fully assembled orientation. As shown, insert 16 is frictionally engaged with striker head 14 by means of an O-ring 24. Alternatively, insert 16 may be threadably engaged with the distal end 26 of striker head 14, As can be seen in Fig, 2, insert 16 has a recess 20 that preferably has an abrasive surface 28 therein for the purpose of cleaning, shaping and/or re-contouring the radius of the tip 18 of stem 12. As further shown in FIG. 2, stem 12 is received within the proximal end 30 of striker head 14. Any suitable means of engaging stem 12 within proximal end 30 of striker head 14 is contemplated. For example, a threaded attachment may be utilized or it may be glued in place.

FIG. 3 is a side view of the call striker 10 showing stem 12, striker head 14 and insert 16 fully engaged with one another. It is also contemplated that insert 16 has an abrasive surface 22 on the exposed portion thereof when it is engaged with striker head 14.

FIG. 4 is a cross-section of insert 16 depicting several additional details thereof. In particular, FIG. 4 shows recess 20, which has a 0.28″ radius which provides a surface suitable for cleaning, shaping and/or re-contouring tip 18 of stem 12. The surface of recess 20 is preferably lined with an abrasive material 28 such as sandpaper, Shown in the mid-region of insert 16 is a groove 32 that is suitable for receiving O-ring 24 for the purpose of frictionally engaging insert 16 within distal end 26 of striker head 14. The head portion 34 of insert 16 may be chamfered to enable easier gripping of insert 16 during insertion and removal from striker head 14. Insert 16, as Weil as striker head 14 may be made of any suitable materials, including molded plastic such as acetal, delrin, polycarbonate, or other moldable materials.

FIG. 5 is a side view of striker head 14. Distal end 26 has an open receiving portion 36 that is designed to receive insert 16 therein. In one embodiment, a portion of striker head 14 has a gripping region 38 to aid in the user's gripping of the call striker during use. Proximal end 30 of striker head 14 is shown with an opening 40 that is sized to receive one end of stem 12.

FIG. 6 is a side view of stem 12 showing tip 18 having a 0.28″ radius and a slightly tapered proximal end 42 which may be tapered at a 15 degree angle for ease of engagement with opening 40 in proximal end 30 of striker head 14. In one embodiment, stem 12 is S/16″ or ¼″ diameter and may be made of Garilite CE or LE. Other suitable materials are known in the art,

The details shown in the Figures and described above in terms of the materials and dimensions are non-limiting. The invention claimed herein is not intended to be limited to the specific details shown and described.

What is claimed is:

1. A call striker, comprising:
a striker stern;
a striker head; and
a striker head insert receivable loan opening in said striker head, wherein said striker head insert includes an exposed surface of a material suitable for conditioning a surface of a call device.

2. The call striker of claim 1, wherein said striker head insert further includes a recess having a material therein suitable for conditioning or shaping a tip of said striker stem.

3. The call striker of claim 1, wherein said exposed surface of a material suitable for conditioning a surface of a call device includes an abrasive material.

4. The call striker of claim 2, wherein said material in said recess suitable for conditioning or shaping a tip of said striker stem is an abrasive material.

5. A call striker, comprising:
a striker stem;
a striker head; and
a striker head insert receivable in an opening in said striker head, wherein said striker head insert includes an exposed surface of an abrasive material suitable for conditioning a surface of a call device and a recess having an abrasive material therein suitable for conditioning or shaping a tip of said striker stem.
